(19) United States
(12) Patent Application Publication
(10) Pub. No.: US 2012/0096360 A1
(43) Pub. Date: Apr. 19, 2012

(54) DATA PROCESSING APPARATUS, DATA PROCESSING METHOD, AND STORAGE MEDIUM

(75) Inventor: Eiichi Nishikawa, Kawasaki-shi (JP)

(73) Assignee: CANON KABUSHIKI KAISHA, Tokyo (JP)

(21) Appl. No.: 12/531,853

(22) PCT Filed: Mar. 30, 2009
(86) PCT No.: PCT/JP09/57008

§ 371 Date: Sep. 17, 2009

(30) Foreign Application Priority Data
Apr. 4, 2008 (JP) 2008-098056

(51) Int. Cl. G06F 3/048

(52) U.S. Cl. 715/731

(57) ABSTRACT

In a data processing apparatus which outputs image data of respective pages included in display data respectively to plural display apparatuses and causes the plural display apparatuses to respectively display the output image data, page designation data for sequentially displaying each page in the plural pages included in the display data respectively on the plural display apparatuses in response to an instruction of a next operation issued from a user is created, and, based on the created page designation data, the image data of the each page in the plural pages included in the display data are output respectively to the plural display apparatuses each time the instruction of the next operation is issued from the user.

### TECHNICAL FIELD

The present invention relates to a data processing apparatus which outputs image data to plural displaying apparatuses and causes these displaying apparatuses to display the output image data, a data processing method which is applied to the data processing apparatus to perform such an operation as described above, and a storage medium which stores thereon software for performing the data processing method.

### BACKGROUND ART

In recent years, a presentation system which utilizes a computer comes into wide use according as image data comes to be digitized, creation of image data becomes easy, definition of a display apparatus such as a display or the like becomes high, and the size of the display apparatus comes to enlarge.

In case of performing presentation, the image data to be used are often prepared every page. Then, according as the progress of the presentation, the image data to be displayed on the display are sequentially switched and displayed based on the operations and the instructions of, for example, a lecturer, its assistant, and the like.

In addition, since manufacturing costs of the display decrease recently, the plural displays are often used simultaneously in one presentation.

If the presentation is thus performed by using the plural displays, the image data of mutually different pages can be simultaneously displayed on the respective displays. Consequently, it is possible to further improve audience's understanding.

Here, as a technique concerning a display operation by using plural displays, for example, Japanese Patent Application Laid-Open No. H05-303483 discloses the technique for sequentially displaying, every page, display data including plural pages by using two or more display apparatuses respectively connected to an electronic computer.

In a case where a presentation person performs a presentation as using the plural displays, he/she has to instruct at any time which page's image data should be displayed on which display during the presentation.

On the other hand, if the technique as disclosed in Japanese Patent Application Laid-Open No. H05-303483 is adopted, the presentation person can cause, by performing a simple operation, the plural displays to sequentially display respective pages included in the image data previously prepared.

However, on the occasion when causing the plural displays to sequentially display the respective pages included in the display image data including the plural pages, there is a case where the presentation person wishes to display the respective pages in the order different from the original page order of the display image data. For example, it is conceivable that, in the state that the first page on which a table of contents has been described is being displayed on one display, the presentation person wishes to sequentially switch and display the second and following pages on other displays.

In such a case, the presentation person eventually has to instruct which page's image data should be displayed on which display, by performing complicated operations during the presentation. For this reason, the load for the presentation person is large.

Besides, in a case where the presentation person is absent, even if a third party acquires the image data to be displayed in the presentation, it is difficult for the third party to cause the plural displays to display the image data of the respective pages in the order that the presentation person intended.

FIG. 18 is a block diagram for describing a workflow of a presentation process.

In FIG. 18, data (display data) 201 which is to be displayed in the presentation is created based on a specific presentation application installed in a computer. Here, it should be noted that the display data 201 includes plural pages (at least pages P1 to P4).

Further, displays D1 to D3 are set up at a conference space, a meeting room or the like which is used for the presentation. Here, it should be noted that each of the displays D1 to D3 is movable independently.

Furthermore, screens 202 to 208 are displayed on the displays D1 to D3 when image data corresponding to the respective pages of the display data are displayed. Here, it should be noted that the same page (P1) is displayed on the screens 202 to 204, and the same page (P3) is displayed on the screens 206 and 207.

In FIG. 18, the page P1 is first displayed on the display D1, and any page is not displayed on the displays D2 and D3. Next, in the state that the page P1 is being displayed on the display D1, the page P2 is displayed on the display D2, and the page P3 is displayed on the display D3. Then, in the state that the page P1 is being displayed on the display D1, the page P3 is displayed on the display D2, and the page P4 is displayed on the display D3.

Conventionally, in a case where the presentation person performs the presentation as displaying the respective pages in the order as illustrated in FIG. 18, it is necessary for the presentation person to perform various operations as illustrated in FIG. 19.

FIG. 19 is a diagram for describing the operations which are necessary to cause the respective displays to display the respective pages in the order illustrated in FIG. 18. In FIG. 19, it should be noted that the display data 201 including the image data of the respective pages illustrated in FIG. 18 have been stored in a storage means 301 provided in an image processing system. In this image processing system, in case of causing the respective displays to display the respective pages of the display data in the order as illustrated in FIG. 18, the following procedure is necessary to the presentation person.

(A) The presentation person instructs the display D1 to display the image of the first page.
(B) The presentation person performs the presentation.
(C) The presentation person instructs the display D2 to display the image of the second page.
(D) The presentation person instructs the display D3 to display the image of the third page.
(E) The presentation person performs the presentation.
(F) The presentation person instructs the display D2 to display the image of the third page.
(G) The presentation person instructs the display D3 to display the image of the fourth page.
(H) The presentation person performs the presentation.

That is, the presentation person has to perform the operations (C) and (D) between the presentations (B) and (E), and perform the operations (F) and (G) between the presentations (E) and (H).

As just described, in case of causing the plural displays to display the respective pages of the display data, the presentation person has to perform the complicated operations between the respective presentations, whereby the load for the presentation person is large.

Besides, in general, a person other than the presentation person cannot exactly judge which page should be displayed on which display at which timing. For this reason, if the presentation person is absent, it is impossible for another person to perform the presentation or reperform the past presentation.

### DISCLOSURE OF THE INVENTION

The present invention has been completed to solve such a conventional problem as described above, and thus the present invention aims to provide a mechanism capable of, in case of performing a presentation by using plural display apparatuses, sequentially switching and displaying desired pages by simple operations.

That is, the present invention provides a data processing apparatus and a data processing method which overcome the above-described problem, and a storage medium which stores thereon software for performing the data processing method.

Under such an object, one aspect of the present invention is to provide a data processing apparatus which outputs image data of respective pages included in display data respectively to plural display apparatuses and causes the plural display apparatuses to respectively display the output image data, comprising: a creating unit configured to create page designation data for sequentially displaying each page in the plural pages included in the display data respectively on the plural display apparatuses in response to an instruction of a next operation issued from a user; and a control unit configured to output, based on the page designation data created by the creating unit, the image data of the each page in the plural pages included in the display data respectively to the plural display apparatuses, each time the instruction of the next operation is issued from the user.

Another aspect of the present invention is to provide a data processing method in a data processing apparatus which outputs image data of respective pages included in display data respectively to plural display apparatuses and causes the plural display apparatuses to respectively display the output image data, the data processing method comprising: creating page designation data for sequentially displaying each page in the plural pages included in the display data respectively on the plural display apparatuses in response to an instruction of a next operation issued from a user; and outputting, based on the created page designation data, the image data of the each page in the plural pages included in the display data respectively to the plural display apparatuses, each time the instruction of the next operation is issued from the user.

Still another aspect of the present invention is to provide a computer-readable storage medium which stores therein a program for causing a computer to perform a data processing method in a data processing apparatus which outputs image data of respective pages included in display data respectively to plural display apparatuses and causes the plural display apparatuses to respectively display the output image data, the data processing method comprising: creating page designation data for sequentially displaying each page in the plural pages included in the display data respectively on the plural display apparatuses in response to an instruction of a next operation issued from a user; and outputting, based on the created page designation data, the image data of the each page in the plural pages included in the display data respectively to the plural display apparatuses, each time the instruction of the next operation is issued from the user.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate the embodiments of the present invention and, together with the description, serve to explain the principle of the present invention.

FIG. 1 is a block diagram for describing the constitution of a data processing system according to the embodiment of the present invention.

FIG. 2 is a diagram for describing a pattern of a presentation in the data processing system according to the embodiment of the present invention.

FIG. 3 is a diagram for describing a presentation person's operation in the presentation.

FIG. 4 is a diagram for describing the data structure of page designation data.

FIG. 5 is a flow chart indicating an example of a first data processing procedure in an information processing apparatus according to the embodiment of the present invention.

FIG. 6 is a diagram for describing page designation data in the data processing system according to the embodiment of the present invention.

FIG. 7 is a diagram illustrating an example of a user interface to be displayed on the internal display apparatus illustrated in FIG. 1.

FIG. 8 is a block diagram for describing the constitution of the data processing system according to the embodiment of the present invention.

FIGS. 9A and 9B are block diagrams illustrating an example of the arrangements of display apparatuses in the data processing system according to the embodiment of the present invention.

FIGS. 10A and 10B are block diagrams for describing a modification of the arrangements of the display apparatuses illustrated in FIGS. 9A and 9B.

FIG. 11 is a diagram illustrating an example of display data and page designation data which are registered in the storage apparatus illustrated in FIG. 1.

FIG. 12 is a diagram illustrating an example of an image data process in the data processing system according to the embodiment of the present invention.

FIG. 13 is a diagram for describing an example of layout output of image data in the data processing system according to the embodiment of the present invention.

FIG. 14 is a diagram for describing an example of the layout output of the image data in the data processing system according to the embodiment of the present invention.

FIGS. 15A and 15B are diagrams illustrating an example of a list constitution in the data processing system according to the embodiment of the present invention.

FIG. 16 is a diagram illustrating an example of a user interface in the data processing system according to the embodiment of the present invention.

FIG. 17 is a diagram for describing a memory map of a storage medium which stores therein various data processing programs capable of being read by a data processing apparatus according to the present invention.

FIG. 18 is a block diagram for describing a presentation process.

FIG. 19 is a diagram for describing a procedure for causing plural display apparatuses to display image data of respective pages according to the related background art, in the presentation process illustrated in FIG. 18.

### BEST MODE FOR CARRYING OUT THE INVENTION

Hereinafter, the exemplary embodiments of the present invention will be described with reference to the attached drawings.

### <Description of System Constitution>

### First Embodiment

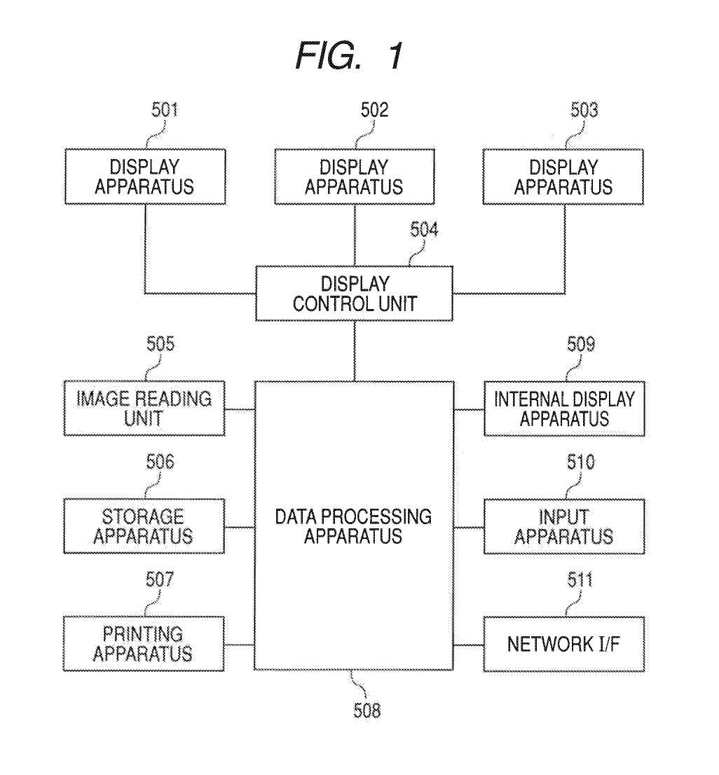

FIG. 1 is a block diagram for describing the constitution of a data processing system according to the present embodiment.

In FIG. 1, display apparatuses 501 to 503 are respectively controlled by a display control unit 504, and image data transferred from a data processing apparatus 508 is displayed on each of the display apparatuses 501 to 503.

As each of the display apparatuses 501 to 503, any display apparatus such as a liquid crystal display, a projector or the like may be used if it can display image data by using a known image display technique. Further, the display apparatuses 501 to 503 may be set up as the display apparatuses dedicated for the data processing apparatus 508. Furthermore, the display apparatuses 501 to 503 may be connected to the data processing apparatus 508 via a wired network or a wireless network.

The display control unit 504 performs control to allocate the storage regions in a VRAM (video random access memory) provided in the data processing apparatus 508 to the display apparatuses 501 to 503 respectively and then to transfer the image data stored in the respective storage regions to the display apparatuses 501 to 503 respectively. Incidentally, it should be noted that the data processing apparatus 508 includes a controller unit having as a CPU (central processing unit), a RAM (random access memory), a ROM (read only memory) and the like and thus controls respective devices connected via an interface.

Further, it should be noted that the display control unit 504 can switch the ON and OFF states of a specific display apparatus by stopping the transfer of the image data to the display apparatuses 501 to 503 or transferring vacant data to the display apparatuses 501 to 503.

An image reading unit 505 reads an image on an original, generates the image data based on the read image, and inputs the generated image data to the data processing apparatus 508. Incidentally, it should be noted that the image data thus input can be transferred to and displayed on the display apparatuses 501 to 503.

In case of performing a copying process, the data processing apparatus 508 performs a process to convert the image data input from the image reading unit 505 into print data, and transfers the acquired print data to a printing apparatus 507. Then, the printing apparatus 507 prints the transferred image data on a recording medium.

Further, in case of performing a printing process, the data processing apparatus 508 receives print data from a client PC (personal computer) or the like connected to the data processing apparatus 508 via a network I/F (interface) 511, and converts the received print data into raster data having a format capable of being printed by the printing apparatus 507. The printing apparatus 507 receives the raster data, and prints the received raster data on a recording medium. Incidentally, it should be noted that the image data based on the print data received from the client PC in such a method as described above can be displayed on the display apparatuses 501 to 503 respectively.

The operation to the data processing apparatus 508 is performed by using an input apparatus 510 which is constituted by a key operation unit, a keyboard, and a pointing device such as a mouse or the like. Incidentally, it should be noted that a signal sent from a remote operation terminal such as a remote controller or the like may be received by a not-illustrated reception unit, and that the received signal may be input via the input apparatus.

An internal display apparatus 509 is used for the operation to the data processing apparatus 508 and display of the state and the like of the data processing apparatus 508. Here, it should be noted that the display on the internal display apparatus 509 and the input from the input apparatus 510 are controlled by a not-illustrated user interface control unit provided in the data processing apparatus 508.

Further, the input process of inputting the image data to the data processing apparatus 508 is achieved by the CPU which executes not-illustrated data creation software by using the internal display apparatus 509 and the input apparatus 510. Here, it should be noted that the data creation software includes a presentation application for performing a presentation process, or the like.

Here, it should be noted that the input process includes a process of inputting an original image by using the image reading unit 505, a process of receiving the image data input from the client PC via the network I/F 511, and the like.

Incidentally, the image data input to the data processing apparatus 508 may be stored in a storage apparatus 506. Further, the data processing apparatus 508 is equipped with a not-illustrated file system for managing and controlling a series of image data as files.

Hereinafter, an example of the presentation in which the display apparatuses 501 to 503 are used will be described.

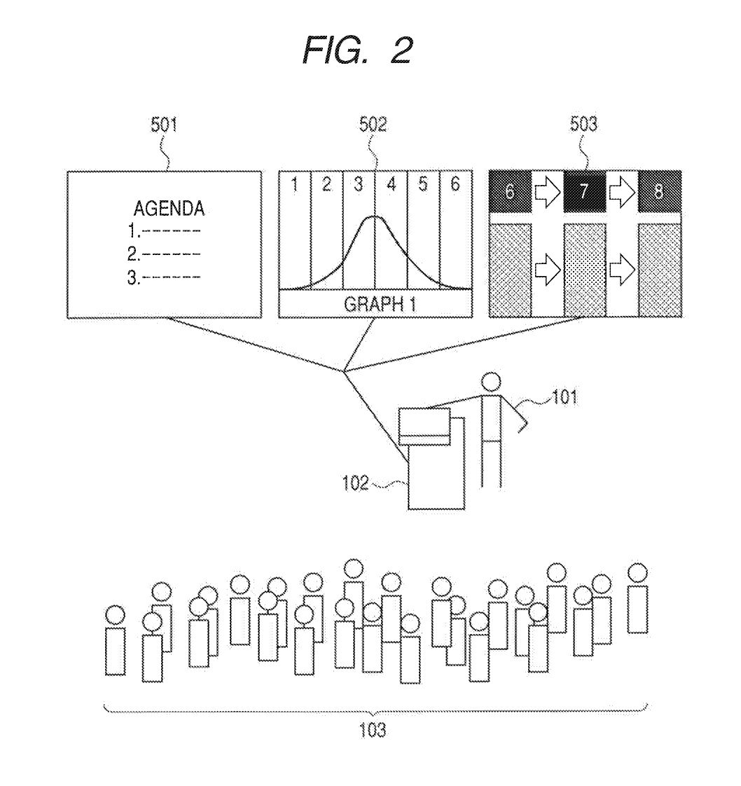

FIG. 2 is a diagram for describing a pattern of the presentation in the data processing system according to the present embodiment. Here, it should be noted that, in FIG. 2, the constituent elements same as those illustrated in FIG. 1 are indicated by the same reference numerals respectively.

In FIG. 2, a presentation person 101 performs a presentation by using a data processing system 102 which has been constituted by the data processing apparatus 508, the display apparatuses 501 to 503 and the like. Further, an audience 103 watches the screens respectively displayed on the display apparatuses 501 to 503.

More specifically, the plural display apparatuses 501 to 503 used in the presentation are respectively connected to the data processing system 102 via interfaces.

If the presentation person 101 operates the input apparatus 510, the data processing system 102 causes the connected display apparatuses 501 to 503 to display the image data corresponding to the respective pages of the display data.

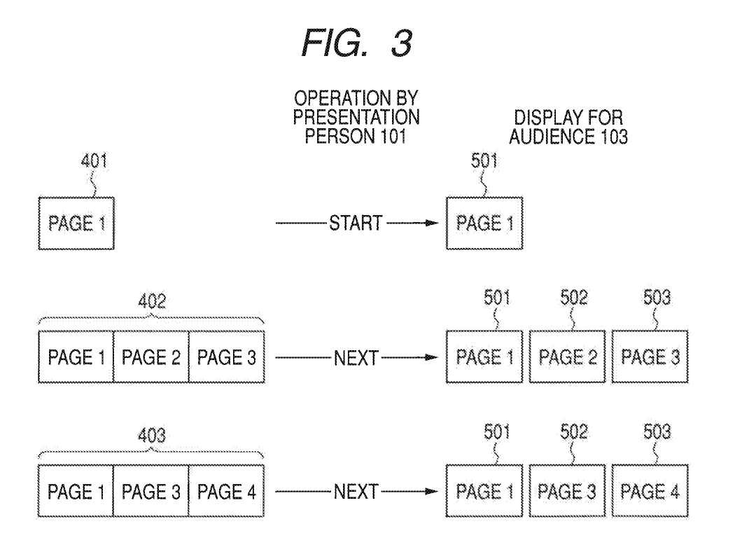

FIG. 3 is a diagram for describing a procedure of the display operation which is performed by the presentation person 101 illustrated in FIG. 2.

In FIG. 3, each of sets 401 to 403 of pages is displayed at a time by the respective display apparatuses at predetermined timing. Further, FIG. 3 indicates page numbers of the pages to be displayed on the respective display apparatuses 501 to 503. Incidentally, page designation data which is the data indicating the display order in case of sequentially displaying mutually different pages from among the plural pages included in the display data respectively on the plural display apparatuses will be described later.

First, in regard to the set 401, the image data of the page 1 is displayed on the display apparatus 501, and any image data is not displayed on the display apparatuses 502 and 503. Here, in the case where any image data is not displayed on the display apparatus, “NULL” is designated in a list designated on a later-described list constitution. If a next operation is instructed by a user in the state that the set 401 is being displayed, the state is shifted to the state that the set 402 is displayed. Incidentally, it is assumed that to instruct the next operation is to input the instruction to the data processing apparatus 508 by depressing once a predetermined button on the input apparatus 510. However, another method may of course be adopted to instruct the next operation. For example, it is possible to automatically input the instruction of the next operation to the data processing apparatus 508 in conjunction with the operation of the presentation person by means of various sensors.

Next, in regard to the set 402, the image data of the page 1 is displayed on the display apparatus 501, the image data of the page 2 is displayed on the display apparatus 502, and the image data of the page 3 is displayed on the display apparatus 503. Then, if a next operation is further instructed by the user in the state that the set 402 is being displayed, the state is shifted to the state that the set 403 is displayed.

In regard to the set 403, the image data of the page 1 is displayed on the display apparatus 501, the image data of the page 3 is displayed on the display apparatus 502, and the image data of the page 4 is displayed on the display apparatus 503. Incidentally, every time the next operation is instructed by the user, the image data of each page is read from the storage apparatus 506 by the file system of the data processing apparatus 508, and the read image data is transferred to the corresponding one of the display apparatuses 501 to 503 under the control of the display control unit 504.

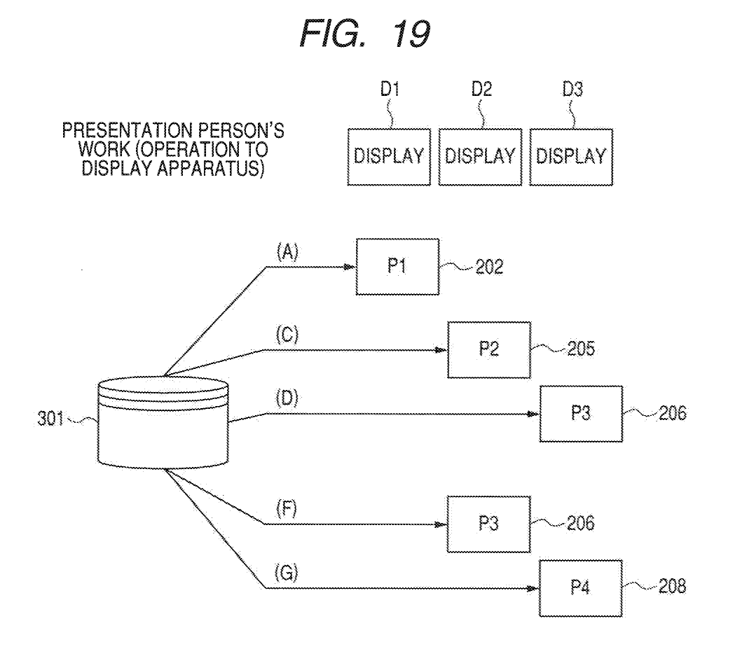

Hereinafter, in relation to the operation which is performed by the presentation person 101, the presentation process according to the present embodiment will be described as comparing the conventional procedure illustrated in FIG. 19 and the procedure of the present embodiment illustrated in FIG. 3 with each other.

In FIG. 19, to display the screen 202 illustrated in FIG. 18, the presentation person 101 has to perform the operation (A). On the other hand, in FIG. 3, the data processing apparatus 508 transfers the image data of the page 1 to the display apparatus 501 and causes the display apparatus 501 to display the transferred image data, according to the instruction of the next operation from the user.

Next, in FIG. 19, to display the screens 203, 205 and 206 illustrated in FIG. 18, the presentation person 101 has to perform the operations (C) and (D). On the other hand, in FIG. 3, the data processing apparatus 508 causes the display apparatus 502 to display the image data of the page 2 and causes the display apparatus 503 to display the image data of the page 3 as keeping causing the display apparatus 501 to display the image data of the page 1, according to the instruction of the next operation from the user.

Further, in FIG. 19, to display the screens 204, 207 and 208 illustrated in FIG. 18, the presentation person 101 has to perform the operations (F) and (G). On the other hand, in FIG. 3, the data processing apparatus 508 causes the display apparatus 502 to display the image data of the page 3 and causes the display apparatus 503 to display the image data of the page 4 as keeping causing the display apparatus 501 to display the image data of the page 1, according to the instruction of the next operation from the user.

Consequently, although the presentation person 101 has to conventionally perform the five operations (A), (C), (D), (F) and (G) to respectively display the screens 202 to 208, the presentation person 101 has only to perform the mere three operations according to the present embodiment. That is, in the present embodiment, the number of operations to be performed by the presentation person can be reduced as compared with the related background art.

Besides, in the present embodiment, one operation can be made easy by previously creating the later-described page designation data. In other words, it is conventionally necessary in one operation to designate which page should be displayed on which display apparatus. However, in the present embodiment, since it is previously designated which page should be displayed on which display apparatus, the presentation person 101 only has to depress at least one predetermined button once.

Therefore, in the case where the presentation person 101 performs the presentation by using the plural display apparatuses, it is possible to reduce operation load for the presentation person 101. Incidentally, the three display apparatuses are used in the present embodiment. However, it should be noted that, as the number of display apparatuses increases, the operation load for the presentation person 101 in the present embodiment can remarkably be reduced.

FIG. 4 is a diagram for describing the data structure of the page designation data according to the present embodiment. Incidentally, it should be noted that the page designation data is the data which indicates which page among the plural pages included in the display data should be displayed on which display apparatus at which timing. Here, although the page designation data is created by executing a specific application in the present embodiment, this data may be created by another method. Incidentally, in the page designation data, a set of each display apparatus and the page to be displayed on the relevant display apparatus is managed in the list constitution.

In FIG. 4, a list constitution 601 is composed of a CAR portion 603 indicating the data of the contents of the list and a CDR portion 602 indicating a next list constitution. In the following, a list constitution may be simply called a list as a matter of convenience.

Hereinafter, the list constitution will be described in detail. Incidentally, it should be noted that, in FIG. 4, the list has a pointer to the next list if the arrow of this list is in contact with the next list, and the list has “NULL (NIL)” there if this list is not in contact with the next list.

In case of performing the presentation illustrated in FIG. 18, lists 604, 612 and 613 indicate the tops of the list constitutions for respectively designating the pages to be displayed on the respective display apparatuses 501, 502 and 503.

Here, a list 605 corresponding to the CAR portion of the list 604 indicates the top of the list constitution for indicating how many displays of the display apparatuses should be controlled in screen transition.

A list 606 follows the CDR portion of the list 605, and a list 607 follows the CDR portion of the list 606.

Since the CDR portion of the list 607 has “NULL”, the list ends there.

Therefore, the display designation of the image data starting from the list 604 designates to cause the three display apparatuses corresponding to the lists 605 to 607 to respectively display the image data.

A list 608 corresponding to the CAR portion of the list 605 has an identifier 609 of “display 1” for identifying the target display apparatus in the CAR portion, and has a list 610 indicating the page to be displayed in the CDR portion.

Here, since the list 610 has “page 1” indicating the page to be displayed in the CAR portion, the series of lists beginning from the CAR portion of the list 605 resultingly designates “display page 1 on display 1”.

The lists 606 and 607 respectively have the identifiers of “display 2” and “display 3” at the respective ends of the list constitutions, but do not have any image data at the respective CAR portions of the lists 611 and 617. For this reason, the series of lists beginning from the CAR portion of the list 606 resultingly designates “do not display any page on display 2”, and the series of lists beginning from the CAR portion of the list 607 resultingly designates “do not display any page on display 3”.

As just described, the series of lists beginning from the CAR portion of the list 604 achieves the designations “display page 1 on display 1”, “do not display any page on display 2” and “do not display any page on display 3”.

Likewise, the series of lists beginning from the CAR portion of the list 612 achieves the designations “display page 1 on display 1”, “display page 2 on display 2” and “display page 3 on display 3”.

Further, the series of lists beginning from the CAR portion of the list 613 achieves the designations “display page 1 on display 1”, “display page 3 on display 2” and “display page 4 on display 3”. Incidentally, it should be noted that the identifiers “display 1” to “display 3” respectively correspond to the display apparatuses 501 to 503 illustrated in FIG. 1.

As described above, the operations which are performed by the presentation person 101 to respectively display the screens 202 to 208 illustrated in FIG. 18 are operations 614 to 616 illustrated in FIG. 4. Then, in response to such operation instructions, the display control unit 504 and the data processing apparatus 508 perform the display control according to the corresponding list constitutions 604, 612 and 613.

An event for switching the list constitution 604 to the list constitution 612 and an event for switching the list constitution 612 to the list constitution 613 are instructed by the presentation person 101 who operates a keyboard, a pointing device and the like constituting the input apparatus 510. Incidentally, there is a possibility that, according to the instruction by the presentation person 101, an assistant of the presentation person 101 instructs these events by operating the keyboard, the pointing device and the like constituting the input apparatus 510.

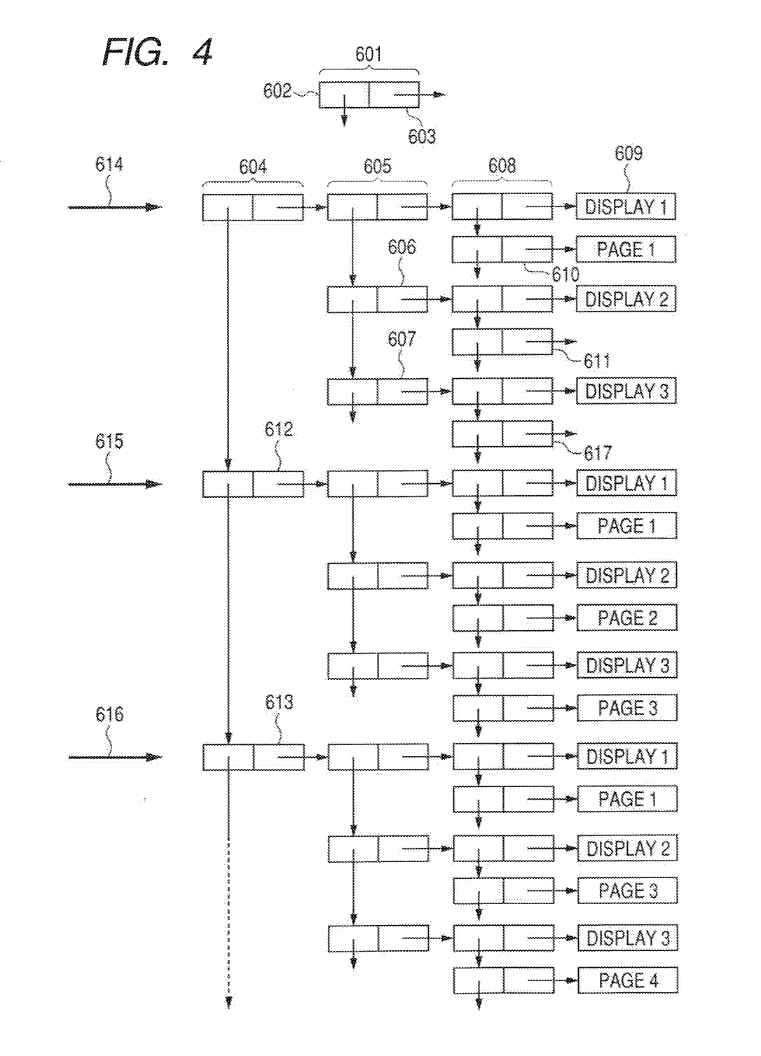

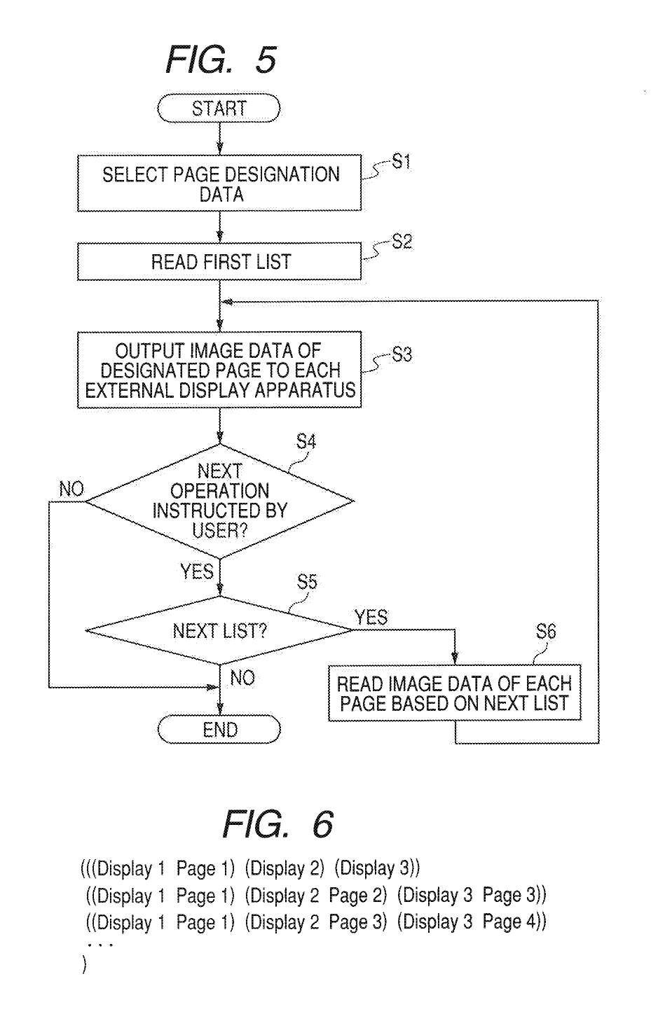

FIG. 5 is a flow chart indicating an example of a first data processing procedure in the information processing apparatus according to the embodiment of the present invention. In this example, a multi-screen presentation for outputting the stored image data of the respective pages to the plural display apparatuses and displaying the output image data on the plural screens of these display apparatuses is performed based on the page designation data stored in the data processing apparatus 508. Here, it should be noted that the flow chart illustrated in FIG. 5 is composed of steps S1 to S6.

Further, it should be noted that the respective steps S1 to S6 are achieved by the CPU of the data processing apparatus 508 which loads the control program stored in the storage apparatus 506 to the RAM and then executes the loaded control program. Incidentally, the first data processing procedure which has been incorporated in a specific presentation application may be started. Alternatively, the first data processing procedure may be directly started as a simple presentation application. In the present embodiment, it is assumed that the first data processing procedure which has been incorporated in the specific presentation application is started.

Therefore, if the presentation application is executed, the first data processing procedure starts. More specifically, in the step S1, the CPU of the data processing apparatus 508 displays a table of the page designation data which have been held in the memory of the data processing apparatus 508. Thus, the presentation person 101 selects the arbitrary page designation data from the displayed table.

Next, in the step S2, the CPU of the data processing apparatus 508 reads the first list of the selected page designation data, and the flow advances to the step S3. Here, it should be noted that the first list of the page designation data indicates the list 604 in, e.g., the case illustrated in FIG. 4.

Then, in the step S3, on the basis of the read page designation data, the CPU of the data processing apparatus 508 reads the image data of each page stored in the storage apparatus 506, and outputs the read image data to the display apparatus corresponding to the identifier designated in the page designation data. Thus, the image data of the page 1 is displayed on the display apparatus 501.

Subsequently, in the step S4, the CPU of the data processing apparatus 508 judges whether or not the presentation person 101 or the assistant of the presentation person 101 instructs the next operation from the input apparatus 510.

Here, if the CPU of the data processing apparatus 508 judges that the presentation person 101 or the assistant of the presentation person 101 instructs the next operation from the input apparatus 510, the CPU of the data processing apparatus 508 further judges in the step S5 whether or not the list corresponding to the next operation exists in the page designation data selected in the step S1. Here, if the CPU of the data processing apparatus 508 judges that the list corresponding to the next operation exists in the page designation data, the flow advances to the step S6. In the step S6, the CPU of the data processing apparatus 508 reads the image data of each page stored in the storage apparatus 506, on the basis of the page designation data. Then, the flow returns to the step S3, and the CPU of the data processing apparatus 508 outputs the read image data to any one of the display apparatuses corresponding to the identifier designated in the page designation data.

Consequently, the image data of the page 1 is displayed on the display apparatus 501, the image data of the page 2 is displayed on the display apparatus 502, and the image data of the page 3 is displayed on the display apparatus 503.

Incidentally, if the CPU of the data processing apparatus 508 judges in the step S4 that the presentation person 101 or the assistant of the presentation person 101 does not instruct the next operation, the process ends.

According to the present embodiment, in the case where the presentation is performed by using the plural display apparatuses, even if the number of the display apparatuses to be used simultaneously increases, the presentation person 101 can cause these display apparatuses to display the image data of the respective pages by simple operations.

### Second Embodiment

FIG. 6 is a diagram for describing the page designation data in the data processing system according to the present embodiment. More specifically, FIG. 6 indicates an example that the list constitution illustrated in FIG. 4 is expressed as text data according to a LISP (LISt Processor) which is one of programming languages.

As just described, it is possible, by describing (Display Data) in the list, to designate the page which should be displayed on the specific display apparatus. Further, it is possible, by providing the plural lists of this type, to designate the pages which should be displayed respectively on the plural displays.

Then, if a not-illustrated interpreter provided in the data processing apparatus 508 interprets the text data, it is possible to determine the pages which should be displayed on the plural display apparatuses 501 to 503 respectively. Then, the data processing apparatus 508 outputs the image data corresponding to the determined pages to the display control unit 504. Consequently, in case of performing the presentation by using the plural display apparatuses 501 to 503, it is possible for the presentation person to cause the external display apparatuses 501 to 503 to display the image data of the intended pages by simple operations.

Further, by storing the generated text data in the storage apparatus 506 and then reading the stored text data again according to the input operation by the input apparatus 510 or the like, it is possible to reenact the image transition which uses the plural display apparatuses used in the presentation.

### Third Embodiment

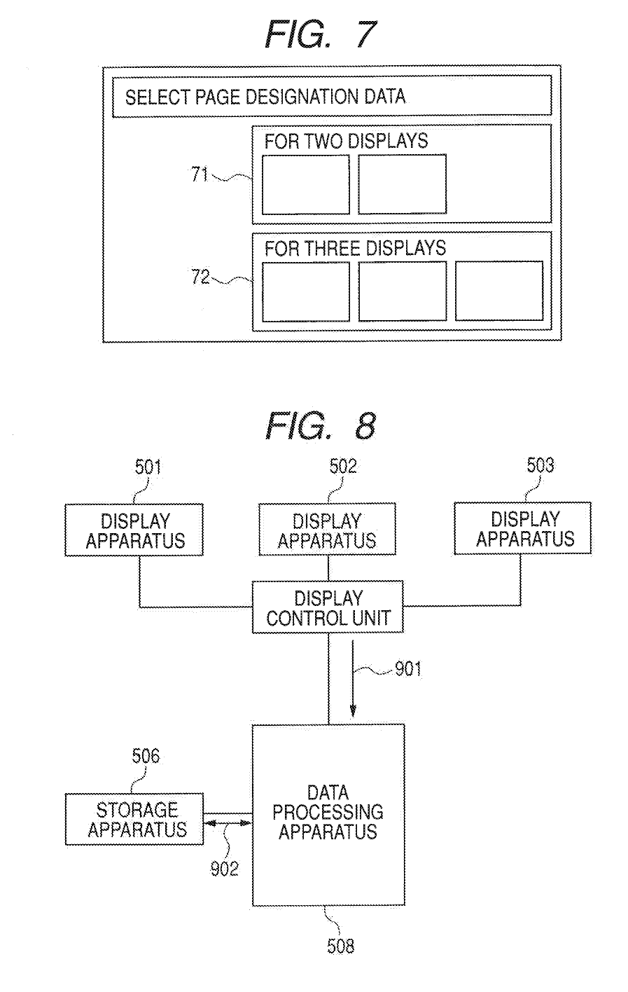

FIG. 7 is a diagram illustrating an example of the user interface to be displayed on the internal display apparatus 509 illustrated in FIG. 1.

In FIG. 7, a button 71 is selected in a case where the presentation is performed by using the two display apparatuses, and a button 72 is selected in a case where the presentation is performed by using the three display apparatuses. More specifically, if the button 71 is selected, the page designation data which has been previously stored in the storage apparatus 506 and in which the respective pages to be displayed so as to be able to perform the presentation by using the two display apparatuses have been designated is read. In addition, if the button 72 is selected, the page designation data which has been previously stored in the storage apparatus 506 and in which the respective pages to be displayed so as to be able to perform the presentation by using the three display apparatuses have been designated is read.

As just described, it is possible to select a display method of the respective pages by storing the plural page designation data having mutually different contents in the storage apparatus 506 and then selecting the arbitrary page designation data via the input apparatus 510.

For example, even in a case where one of the provided three display apparatuses is unusable due to a failure or the like, if there is the page designation data which has been created to perform the presentation by using the two display apparatuses, to perform and reperform the presentation are not obstructed.

### Fourth Embodiment

FIG. 8 is a block diagram for describing the constitution of the data processing system according to the present embodiment.

More specifically, FIG. 8 indicates an example of automatically selecting adequate page designation data from among the plural page designation data stored in the storage apparatus 506, according to the number of the display apparatuses connected to the data processing system.

In FIG. 8, communication data 901 includes the number of the display apparatuses to be notified from the display control unit 504 to the data processing apparatus 508. Then, according to the notified number of the display apparatuses, the data processing apparatus 508 automatically selects the adequate the page designation data from among the plural page designation data stored in the storage apparatus 506, and then receives the selected page designation data as communication data 902.

Thus, even if the presentation person 101 does not perform an operation for selecting the page designation data on the input apparatus 510, he/she can read from the storage apparatus 506 the adequate page designation data according to the number of the usable display apparatuses.

### Fifth Embodiment

In case of performing the presentation by using the plural display apparatuses, the arrangement (layout) of the display apparatuses which respectively display the image data is important.

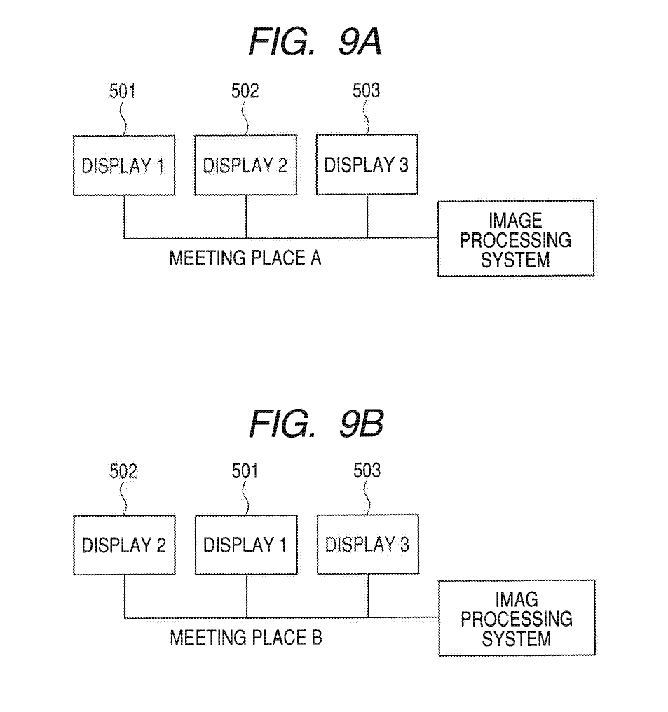

FIGS. 9A and 9B are block diagrams illustrating an example of the arrangements of the display apparatuses in the data processing system according to the present embodiment.

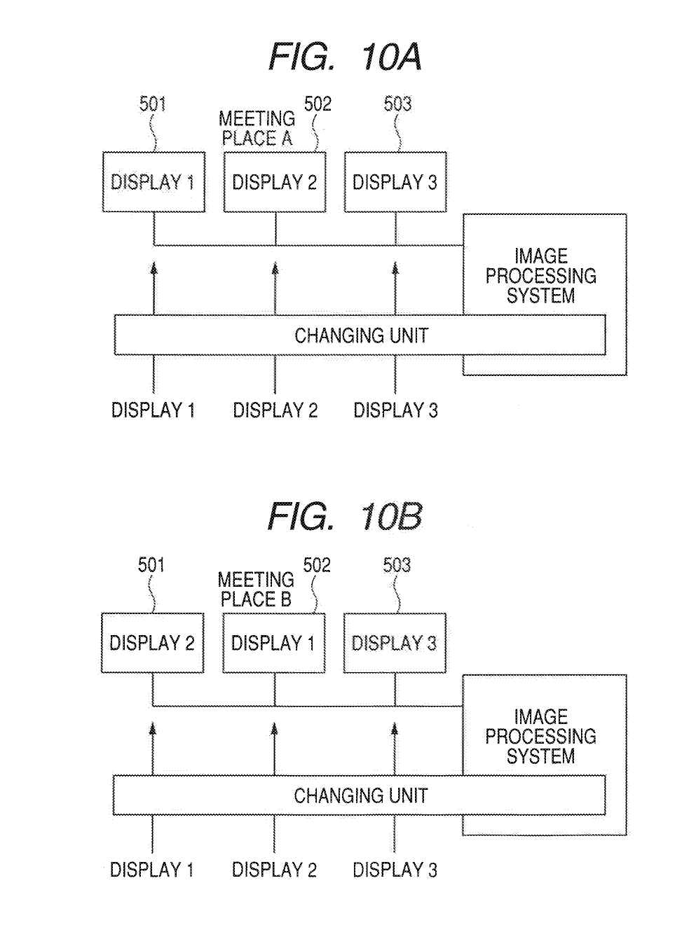

FIGS. 10A and 10B are block diagrams for describing a modification of the arrangements of the display apparatuses illustrated in FIGS. 9A and 9B.

For example, in regard to the data which has been created in consideration of the presentation to be performed on a meeting place A as illustrated in FIG. 9A, the designation for the display apparatus 501 and the designation for the display apparatus 502 have to be replaced with each other in the presentation to be performed on a meeting place B as illustrated in FIG. 9B.

However, in case of performing such replacement, if the number of the display apparatuses to be used increases, a work load for changing the page designation data becomes large.

For this reason, in the example illustrated in FIGS. 10A and 10B, a changing unit for changing the display apparatuses being the output destinations of the image data is provided. Thus, the changing unit automatically changes the output destinations according to the change of the arrangement of the display apparatuses.

In the present embodiment, the output to the display apparatus 501 (display 1) on the meeting place A as illustrated in FIG. 10A is changed to the output to the display apparatus 502 (display 1) on the meeting place B as illustrated in FIG. 10B. Further, the output to the display apparatus 502 (display 2) on the meeting place A as illustrated in FIG. 10A is changed to the output to the display apparatus 501 (display 2) on the meeting place B as illustrated in FIG. 10B.

Incidentally, the changing unit may automatically correct the contents of the page designation data created in the data processing apparatus 508. In addition, the display control unit 504 may change the output destination without changing the contents of the page designation data itself.

Thus, it is possible to flexibly cope with the change of the arrangement of the respective display apparatuses to be used when the presentation is performed. In addition, it is possible to reduce the work load for changing the page designation data to cope with such an arrangement change.

### Sixth Embodiment

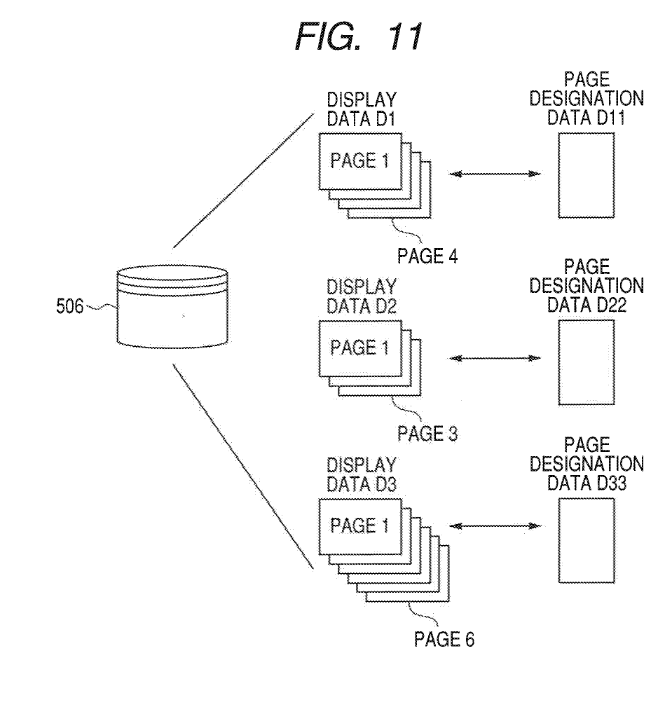

FIG. 11 is a diagram illustrating an example of display data and page designation data which are registered in the storage apparatus 506 illustrated in FIG. 1.

In the present embodiment, in a case where display data D1, D2 and D3 each of which includes plural pages are registered in the storage apparatus 506, page designation data D11, D22 and D33 respectively corresponding to the display data D1, D2 and D3 are held as making the page designation data D11, D22 and D33 respectively correspond to the display data D1, D2 and D3.

Thus, even in a case where the plural display data each of which includes a series of image data beginning from “page 1” are stored in the storage apparatus 506, an operation load for selecting the page designation data is reduced. In other words, if the display data stored in the storage apparatus 506 is selected by the presentation person 101, the page designation data corresponding to the selected display data is automatically selected. Consequently, it is unnecessary for the presentation person 101 to be at the trouble of selecting the page designation data.

Incidentally, it is unnecessary for the display data and the page designation data to satisfy one-to-one correspondence. That is, it is possible to make one page designation data correspond to plural display data and vice versa. For example, if the one page designation data corresponds to the plural display data, it is unnecessary for a user to individually create the page designation data for each display data, whereby the work load can be reduced. Also, in this case, since it is unnecessary to hold a large number of page designation data, memory resources can be saved.

On the other hand, it is possible to make one display data correspond to plural page designation data. For example, as described in the third embodiment, it is possible to previously create the page designation data for the presentation to be performed by using the two display apparatuses and the page designation data for the presentation to be performed by using the three display apparatuses, and then hold the two page designation data as making them correspond to the one display data.

### Seventh Embodiment

In the above-described first embodiment, it is assumed that the number of the display apparatuses that was considered at the time when the page designation data was created is the same as the number of the display apparatuses at the meeting place where the presentation is actually performed.

However, there is a possibility that the number of the display apparatus that was considered at the time when the page designation data was created is different from the number of the display apparatuses at the meeting place where the presentation is actually performed for some reasons of the meeting place or a failure of the display apparatus. In the following, the case where the number of the display apparatus that was considered at the time when the page designation data was created is different from the number of the display apparatuses at the meeting place where the presentation is actually performed will be described.

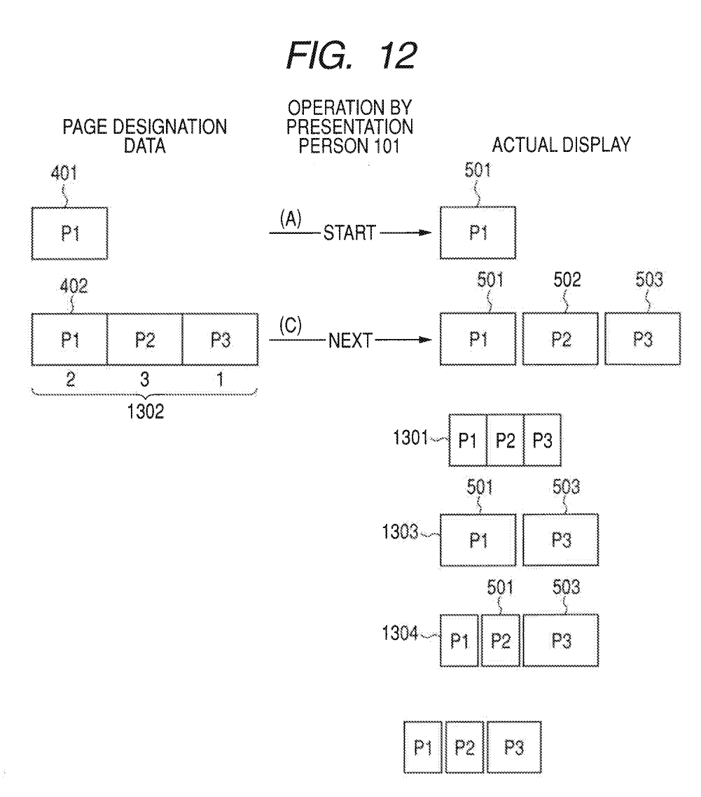

FIG. 12 is a diagram illustrating an example of an image data process in the data processing system according to the present embodiment.

Here, FIG. 12 is directed to an example of automatically correcting the content of the previously created page designation data according to the number of the display apparatuses to be used. Further, the example illustrated in FIG. 12 indicates a case where the number of the display apparatuses capable of being used in the meeting place is two in regard to the page designation data created on the premise that the three display apparatuses are used. Incidentally, it should be noted that, in FIG. 12, the elements same as those illustrated in FIG. 3 are indicated by the same reference numerals respectively.

In FIG. 12, as indicated by a state 1302, it has been designated by the page designation data to display pages P1, P2 and P3 respectively on three external display apparatuses 501, 502 and 503. However, only the two display apparatuses can be used in practice.

For this reason, in the present embodiment, the page designation data which has been created on the premise that the three external display apparatuses 501 to 503 are used is automatically corrected so as to be able to display the pages P1 to P3 by using the two external display apparatuses 501 and 503.

More specifically, in a first correction example, as indicated by a state 1301, the page designation data is corrected so as to lay out the image data of the three pages so that the equally reduced image data of the three pages P1 to P3 can be displayed by the two display apparatuses.

Further, in a second correction example, as indicated by the state 1302, the page designation data is corrected by using priority information. Here, it should be noted that the priority information is previously designated by the presentation person 101 at the time when he/she creates the page designation data. Then, as indicated by a state 1303, the page designation data is corrected so that the pages P1 and P3 of which the priority orders are higher are selected from among the pages P1 to P3 and displayed respectively on the display apparatuses 501 and 503 and the page P2 of which the priority order is low is not displayed.

Furthermore, in a third correction example, as well as the second correction example, the page designation data is corrected by using the priority information. That is, as indicated by a state 1304, the page designation data is corrected so that the page P3 of which the priority order is highest is directly displayed on the display apparatus 503 and the pages P1 and P2 of which the priority orders are lower are reduced and then together displayed on the display apparatus 501.

On the other hand, a case where the number of the display apparatuses capable of being used at the meeting place is larger than the number of the display apparatuses that was considered at the time when the page designation data was created will be described hereinafter.

That is, if the number of the display apparatuses provided at the meeting place is large, the data processing apparatus 508 corrects the page designation data so as to display on a large scale the image data of the page of the highest priority order over the screens of the plural display apparatuses. Alternatively, the data processing apparatus 508 may correct the page designation data so that the page of the highest priority order or the image data of the page to which “Agenda” has been designated is displayed at all times on any display apparatus. Besides, at this time, it is possible to correct the page designation data so that an extra display apparatus is not used.

### Eighth Embodiment

In the following, an automatic registration process of registering the page designation data in a system which performs a registration process of registering the display data to be stored in the storage apparatus 506 illustrated in FIG. 1 and a transmission process of transmitting the display data will be described.

In FIG. 1, the data processing apparatus 508 receives the image data transmitted from an external apparatus by using the network I/F 511 and stores the received image data in the storage apparatus 506.

Further, the data processing apparatus 508 transmits the image data stored in the storage apparatus 506 outward by using the network I/F 511, based on an instruction issued from the input apparatus 510.

In the data processing system having such a configuration as described above, the data processing apparatus 508 receives the above-described page designation data together with the image data (display data) from the external apparatus, and registers the received data in the storage apparatus 506.

Thus, in the data processing apparatus 508, a work load which is necessary in the process of creating the page designation data in regard to the display data registered in the storage apparatus 506 and the process of registering the created page designation data can be reduced.

### Ninth Embodiment

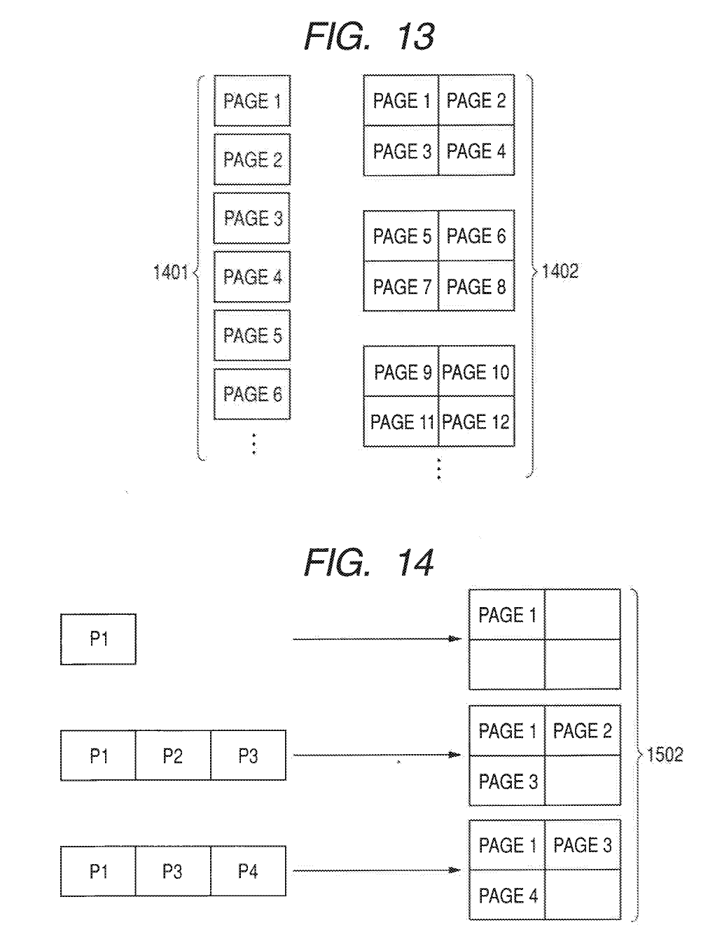

FIGS. 13 and 14 are diagrams for describing an example of layout output of the image data in the data processing system according to the present embodiment.

More specifically, FIG. 13 indicates a general layout output process to be performed by the printing apparatus 507 illustrated in FIG. 1.

In FIG. 13, display data 1401 which includes plural pages has been stored in the storage apparatus 506. Further, a layout output 1402 is an example of 4-in-1 output in which the image data of four pages are laid out and output onto a single side of one storage medium.

In the present embodiment, the layout output in which the content of the page designation data has been reflected is performed by using the printing apparatus 507 which has such a layout print processing function.

As described above, in the presentation in which the plural display apparatuses are used, if the image data of the plural pages which are mutually relevant to others are simultaneously displayed, it is possible to provide the presentation which can be easily understood by an audience. For this reason, in a case where the display data used in the presentation is printed by the printing apparatus 507, it is desirable to lay out as much as possible the display data according to the combination of the pages displayed in the presentation.

Therefore, in the example illustrated in FIG. 14, the data processing apparatus 508 automatically selects, from among the plural pages included in the display data, the pages to be laid out and output on one recording medium, according to the content of the page designation data. Then, the printing apparatus 507 obtains a layout 1502 by laying out the image data of the pages selected by the data processing apparatus 508.

Thus, it is possible to lay out and output the image data of the plural relevant pages.

### Tenth Embodiment

In the above-described first embodiment, the page to be displayed in the presentation is designated by using the list constitution illustrated in FIG. 4. In this case, it is premised that the image data of each page to be displayed is included in one display data stored in the storage apparatus 506 illustrated in FIG. 1. However, the image data to be displayed on the display apparatus may be acquired by another method. That is, in the present embodiment, it is possible to designate that the image data of a page included in another display data stored in the storage apparatus 508 is displayed on the display apparatus. Alternatively, it is possible tot designate that the image data of the page to be displayed is acquired from an external data source connected via the network I/F 511 and the acquired image data is displayed on the display apparatus. In any case, the present embodiment will be described hereinafter.

In the present embodiment, a server apparatus which manages contents is assumed as the external data source. Here, it is further assumed that the server apparatus includes a storage apparatus and provides in the storage apparatus a function to register various contents in the storage apparatus and thus respond to acquisition requests from the network.

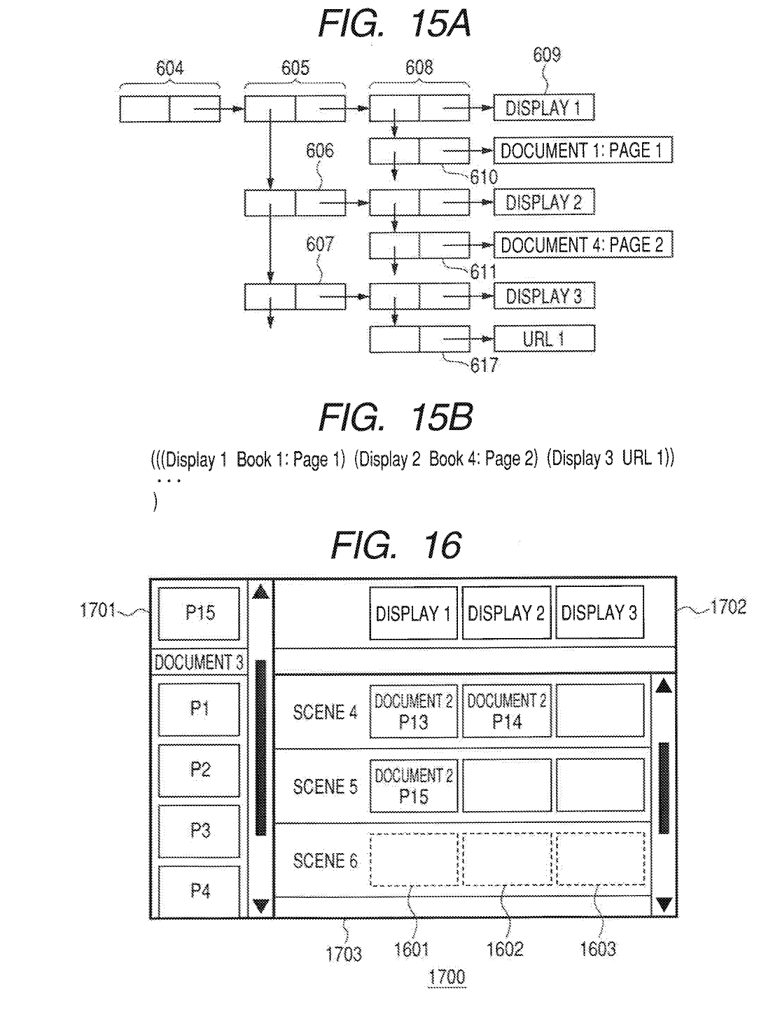

FIGS. 15A and 15B are diagrams illustrating an example of the list constitution in the data processing system according to the present embodiment. Here, in this example, a URL (Uniform Resource Locater) corresponding to the image data of the page intended to be displayed in the list of the list constitution illustrated in FIG. 4 is designated. Incidentally, FIG. 15A indicates a case where the URL is designated in the list constitution, and FIG. 15B indicates a case where the same URL is designated based on text data.

In the present embodiment illustrated in FIG. 15A, it is designated to display the image data corresponding to the page 1 of the first display data (document 1) on “display 1”, and it is further designated to display the image data corresponding to the page 2 of the second display data (document 4) on “display 2”. Furthermore, in the CAR portion of the list 617, “URL 1” is designated as the URL corresponding to the image data stored in the external data source.

Thus, the image data corresponding to the URL 1 is displayed on “display 3”. Incidentally, as described above, the image data designated by the URL 1 is acquired by the data processing apparatus 508.

Consequently, it is possible to combine the image data of the respective pages included in the plural display data stored in the storage apparatus 506 and the image data acquired from another data source and then display the acquired image data respectively on the plural display apparatuses by simple operations.

Incidentally, in a case where the data processing apparatus 508, the display control unit 504, the display apparatus 501, the display apparatus 502 or the display apparatus 503 has a moving image display function, it is possible, by designating moving image data in the CAR portion of the list, to reproduce a moving image according to the designated moving image data on a specific display.

### Eleventh Embodiment

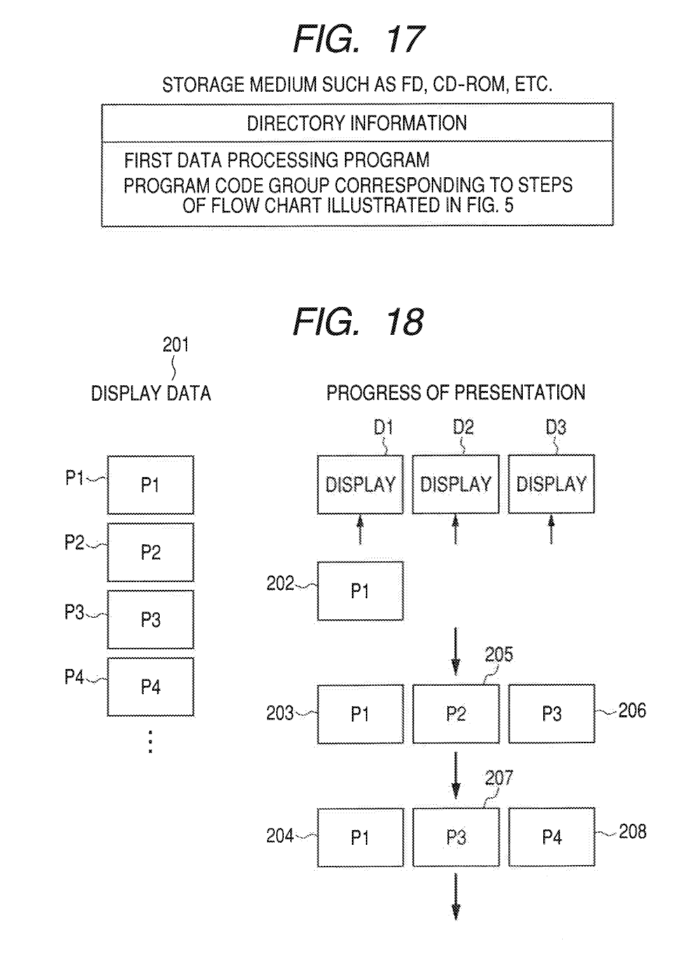

FIG. 16 is a diagram illustrating an example of a user interface in the data processing system according to the present embodiment. Here, it should be noted that a user interface 1700 illustrated in FIG. 16 is displayed on the internal display apparatus 509 illustrated in FIG. 1 and used to create the page designation data. Incidentally, the user interface 1700 is displayed according to the application stored in the data processing apparatus 508.

In FIG. 16, a page selection region 1701 is the portion on which the image data to be displayed on the display apparatus is selected. In the present embodiment, the page intended to be displayed can be selected by the input apparatus 510 from among the plural pages included in the display data.

In this case, an operator can select the name of the display data displayed in the page selection region 1701 of the user interface 1700 and the image data of the page included in each display data, by operating the input apparatus 510.

On a display apparatus selection region 1702, the display apparatus for displaying the image data of the page selected on the page selection region 1701 is designated. In the present embodiment, since the image display apparatuses 501 to 503 are usable as the destination to which the image data is output, it is possible to create the page designation data which is directed to the three display apparatuses.

Further, on a display region 1703, it is clearly specified what kind of content should be displayed on each of the plural display apparatuses 501 to 503.

Incidentally, in the present embodiment, an indication of display changing is described as “scene”. Here, it is possible to designate the pages of which the number is equivalent to the number of the display apparatuses to be used in each scene.

Further, in the present embodiment, any display apparatus is not displayed in regard to the portion where any page is not designated. Furthermore, any designation as to whether or not to display image data is not yet performed in regard to regions 1601 to 1603 surrounded by the dotted lines.

In the following, a page designation data creating process which is performed by using the user interface 1700 will be described.

The operator first designates the pages to be displayed on the display region 1703 by referring to the longitudinal arrangement of the display apparatuses on the display apparatus selection region 1702 of the user interface 1700 displayed on the internal display apparatus 509.

As just described, according to the present embodiment, it is possible to intuitively recognize which page corresponds to which display apparatus, by only watching the display apparatus selection region 1702 of the user interface 1700. Incidentally, it should be noted that the order of arranging the display apparatuses 501 to 503 on the display apparatus selection region 1702 can be changed properly.

Next, the operator selects the pages to be displayed from the page selection region 1701, and designates the pages to be displayed for each scene on the display region 1703.

Then, if the operator selects a not-illustrated OK button or the like on the user interface 1700, the data processing apparatus 508 executes the application to create the page designation data for causing the display apparatus to display the image data of the pages designated on the display region 1703.

Thus, it is possible for a user to easily create the page designation data for causing the plural display apparatuses to display the image data, by performing simple operations to the user interface 1700.

### Twelfth Embodiment

Hereinafter, the architecture of data processing programs readable by the information processing apparatus according to the present invention will be described with reference to a memory map illustrated in FIG. 17.

FIG. 17 is the diagram for describing the memory map of the storage medium which stores thereon various data processing programs capable of being read by the information processing apparatus according to the present invention.

Incidentally, although it is not illustrated specifically, also information (e.g., version information, creator information, etc.) for administrating the program groups stored on the storage medium may occasionally be stored, and information (e.g., icon information for discriminatively displaying a program, etc.) depending on an OS or the like on the program reading side may occasionally be stored.

Moreover, the data depending on the various programs are administrated on the directory of the storage medium. Besides, a program to install various programs into a computer, a program to uncompress installed programs and data when the installed programs and data have been compressed, and the like are occasionally stored.

Furthermore, the functions illustrated in FIG. 5 may be executed by a host computer on the basis of externally installed programs. In that case, the present invention is applicable even in a case where an information group including programs is supplied from a storage medium such as a CD-ROM, a flash memory, an FD or the like or an external storage medium through a network to an output apparatus.

Incidentally, it is needless to say that the object of the present invention can be achieved also in a case where the storage medium storing the program codes of software to realize the functions of the above-described embodiments is supplied to a system or an apparatus and then a computer (or CPU or MPU) in the system or the apparatus reads and executes the program codes stored on the storage medium.

In that case, the program codes themselves read from the storage medium realize the new functions of the present invention, whereby the storage medium storing these program codes constitutes the present invention.

Therefore, because the form of program is no object if it has an actual function as the program, an object code, a program executed by an interpreter, script data supplied to an OS, and the like may be included as the program.

As the storage medium for supplying the program codes, for example, a flexible disk, a hard disk, an optical disk, a magnetooptical disk, a CR-ROM, a CD-R, a CD-RW, a magnetic tape, a nonvolatile memory card, a ROM, a DVD or the like can be used.

In this case, the program codes themselves read from the storage medium realize the functions of the above-described embodiments, whereby the storage medium storing these program codes constitutes the present invention.

Besides, as a method of supplying programs, there is a method of connecting with a website on the Internet by using a browser of a client computer, and downloading the computer program itself of the present invention or a compressed file including an automatic installing function together with the computer program into the recording medium such as a hard disk or the like. Moreover, there is a method of dividing the program codes constituting the program of the present invention into plural files and downloading the respective files from different websites. That is, a WWW server, an FTP (file transfer protocol) server and the like for downloading the program files for achieving the function processes of the present invention with use of the computer to plural users are included in the scope of the present invention.

Moreover, it is possible to encrypt the program of the present invention, store the encrypted program in a storage medium such as a CD-ROM or the like, distribute the obtained storage media to the users, cause the user who has satisfied a predetermined condition to download key information for decrypting the encrypted program from the website through the Internet, cause the user in question to install the decrypted program into an appropriate computer, and thus achieve the functions of the present invention.

Moreover, it is needless to say that the present invention includes not only a case where the functions of the above-described embodiments are realized by executing the program codes read by the computer, but also a case where an OS (operating system) or the like functioning on the computer executes a part or all of the actual process according to instructions of the program codes, whereby the functions of the above-described embodiments are achieved by that process.

Furthermore, it is needless to say that the functions of the above-described embodiments can be achieved in a case where the program read from the storage medium is once written in a memory provided in a function expansion board inserted in the computer or a function expansion unit connected to the computer, and then a CPU or the like provided in the function expansion board or the function expansion unit executes a part or all of the actual process according to the instructions of the program.

While the present invention has been described with reference to what is presently considered to be the preferred embodiment, it is to be understood that the present invention is not limited to the disclosed embodiments. On the contrary, the present invention is intended to cover various modifications and equivalent arrangements (including the organic combination of the respective embodiments) included within the spirit and scope of the appended claims. The scope of the following claims is to be accorded the broadest interpretation so as to encompass all such modifications and equivalent structures and functions.

Although the embodiments have been explained by way of various examples, it is apparent for one of ordinary skill in the art that the purpose and the scope of the present invention are not limited to the specific explanations described in the present application.

This application claims the benefit of Japanese Patent Application No. 2008-098056, filed Apr. 4, 2008, which is hereby incorporated by reference herein in its entirety.

1. A data processing apparatus which outputs image data of respective pages included in display data respectively to plural display apparatuses and causes the plural display apparatuses to respectively display the output image data, comprising:
a creating unit configured to create page designation data for sequentially displaying each page in the plural pages included in the display data respectively on the plural display apparatuses in response to an instruction of a next operation issued from a user; and
a control unit configured to output, based on the page designation data created by the creating unit, the image data of the each page in the plural pages included in the display data respectively to the plural display apparatuses, each time the instruction of the next operation is issued from the user.

2. A data processing apparatus according to claim 1, further comprising a storage unit configured to store the display data,
wherein, each time the instruction of the next operation is issued from the user, the control unit reads from the storage unit the image data of the pages which should be displayed respectively on the plural display apparatuses and outputs the read image data respectively to the plural display apparatuses.

3. A data processing apparatus according to claim 2, further comprising a holding unit configured to hold the page designation data created by the creating unit, as making the held page designation data correspond to the display data stored by the storage unit.

4. A data processing apparatus according to claim 3, wherein the holding unit holds the plural page designation data having mutually different contents, as making the held page designation data correspond to the one display data stored by the storage unit.

5. A data processing apparatus according to claim 1, wherein the creating unit creates the page designation data according to an instruction from the user.

6. A data processing apparatus according to claim 1, further comprising a correction unit configured to automatically correct a content of the page designation data by comparing the number of the display apparatuses capable of being used as output destinations of the image data and the number of the display apparatuses designated as output destinations of the image data in the page designation data with each other.

7. A data processing apparatus according to claim 1, further comprising a printing unit configured to lay out and print the image data of the respective pages simultaneously displayed respectively on the plural display apparatuses.

8. A data processing apparatus according to claim 1, wherein, in a case where a specific presentation application has been started, the control unit performs output of the image data each time the instruction of the next operation is issued from the user.

9. A data processing method in a data processing apparatus which outputs image data of respective pages included in display data respectively to plural display apparatuses and causes the plural display apparatuses to respectively display the output image data, the data processing method comprising:
creating page designation data for sequentially displaying each page in the plural pages included in the display data respectively on the plural display apparatuses in response to an instruction of a next operation issued from a user; and
outputting, based on the created page designation data, the image data of the each page in the plural pages included in the display data respectively to the plural display apparatuses, each time the instruction of the next operation is issued from the user.

10. A computer-readable storage medium which stores therein a program for causing a computer to perform a data processing method in a data processing apparatus which outputs image data of respective pages included in display data respectively to plural display apparatuses and causes the plural display apparatuses to respectively display the output image data, the data processing method comprising:
creating page designation data for sequentially displaying each page in the plural pages included in the display data respectively on the plural display apparatuses in response to an instruction of a next operation issued from a user; and
outputting, based on the created page designation data, the image data of the each page in the plural pages included in the display data respectively to the plural display apparatuses, each time the instruction of the next operation is issued from the user.
